(19) United States
(12) Patent Application Publication
(10) Pub. No.: US 2024/0015820 A1
(43) Pub. Date: Jan. 11, 2024

(54) METHOD AND APPARATUS FOR RELAY TRANSMISSION

(71) Applicant: LENOVO (BEIJING) LIMITED, Beijing (CN)

(72) Inventors: Congchi Zhang, Shanghai (CN); Mingzeng Dai, Shanghai (CN); Lianhai Wu, Beijing (CN); Jing Han, Beijing (CN)

(73) Assignee: Lenovo (Beijing) Limited, Beijing (CN)

(21) Appl. No.: 18/249,872

(22) PCT Filed: Oct. 21, 2020
(86) PCT No.: PCT/CN2020/122390

§ 371 Date: Apr. 20, 2023

(51) Int. Cl. H04W 76/14; H04W 76/30; H04W 76/18

(52) U.S. Cl. CPC H04W 76/14; H04W 76/30; H04W 76/18

(57) ABSTRACT

The present disclosure relates to a method and apparatus for relay transmission. The method is performed by a first UE. The method comprises activating a first timer after a first path to a second UE determined as failed; transmitting a first discovery message; and inactivating the first timer upon receipt of a first acceptation message responsive to the first discovery message.

### TECHNICAL FIELD

Embodiments of the present disclosure generally relate to wireless communication technology, especially to a method and apparatus for relay transmission.

### BACKGROUND

The study item on new radio (NR) sidelink relay was agreed in RAN 86e for Release 17 (i.e., RP-193253). The sidelink relay may include sidelink-based UE-to-Network relay and UE-to-UE relay.

Sidelink may be a direct link for communications between devices. Sidelink may be used for communication of device-to-device (e.g., proximity service), communication of vehicle-to-vehicle, communication of vehicle-to-pedestrian, internet of things, and communication for wearable devices. Sidelink may provide different operations for end-to-end communication. For example, sidelink may provide distributed control and managements among devices, direct communication within or without network coverage, and extended coverage of communication through relay.

In Release 17, criteria and procedure of relay selection (or reselection) and service continuity are studied. In relay communication, robust and efficient relay selection (or reselection) and data continuity are highly beneficial.

### SUMMARY OF THE APPLICATION

Some embodiments of the present disclosure at least provide a technical solution for relay communications.

Some embodiments of the present disclosure provide a method for relay reselection. The method is performed by a first user equipment (UE). The method comprises: activating a first timer after a first path to a second UE determined as failed; transmitting a first discovery message; inactivating the first timer upon receipt of a first acceptation message responsive to the first discovery message.

Some other embodiments of the present disclosure provide a method for relay reselection. The method is performed by a first UE. The method comprises: activating a first timer after a first path to a second UE determined as failed; and inactivating the first timer upon receipt of a first discovery message from the second UE; and transmitting a first acceptation message responsive to the first discovery message if the first discovery message is received when the first timer is active.

Some other embodiments of the present disclosure provide a method for relay reselection. The method is performed by a first UE. The method comprises: receiving a first discovery message from a second UE; and discarding the first discovery message associated with a connection if a first path of the connection is determined as failed.

Some embodiments of the present disclosure also provide an apparatus, including at least one non-transitory computer-readable medium having computer executable instructions stored therein, at least one receiver, at least one transmitter, and at least one processor coupled to the at least one non-transitory computer-readable medium, the at least one receiver, and the at least one transmitter. The computer executable instructions are programmed to implement any method as described, with the at least one receiver, the at least one transmitter, and the at least one processor.

Embodiments of the present disclosure provide a technical solution for relay communication. Accordingly, embodiments of the present disclosure can provide superior reselection procedure and data continuity between the end UEs of relay communication.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure;

FIG. 2 is a schematic diagram illustrating exemplary protocol stack according to some embodiments of the present disclosure;

FIG. 3 is a flowchart of a method for relay establishment according to some embodiments of the present disclosure;

FIG. 4 is a flowchart of a method for relay establishment according to some embodiments of the present disclosure;

FIG. 5 is a flowchart of a method for relay reselection according to some embodiments of the present disclosure;

FIG. 6 is a flowchart of a method for relay reselection according to some embodiments of the present disclosure;

FIG. 7 is a flowchart of a method for relay reselection according to some embodiments of the present disclosure;

FIG. 8 is a flowchart of a method for relay reselection according to some embodiments of the present disclosure;

FIG. 9 is a flowchart of a method for relay reselection according to some embodiments of the present disclosure;

FIG. 10 is a flowchart of a method for relay reselection according to some embodiments of the present disclosure;

FIG. 11 is a flowchart of a method for relay reselection according to some embodiments of the present disclosure;

FIG. 12 is a flowchart of a method for relay reselection according to some embodiments of the present disclosure;

FIG. 13 is a flowchart of a method for a UE according to some embodiments of the present disclosure;

FIG. 14 is a flowchart of a method for a UE according to some embodiments of the present disclosure;

FIG. 15 is a flowchart of a method for a UE according to some embodiments of the present disclosure; and

FIG. 16 is a simplified block diagram of an apparatus for relay communication according to some embodiments of the present disclosure.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as 3GPP 5G New Radio (NR), 3GPP long-term evolution (LTE) Release 8 and so on. Persons skilled in the art know very well that, with the development of network architecture and new service scenarios, the embodiments in the present disclosure are also applicable to other similar technical problems.

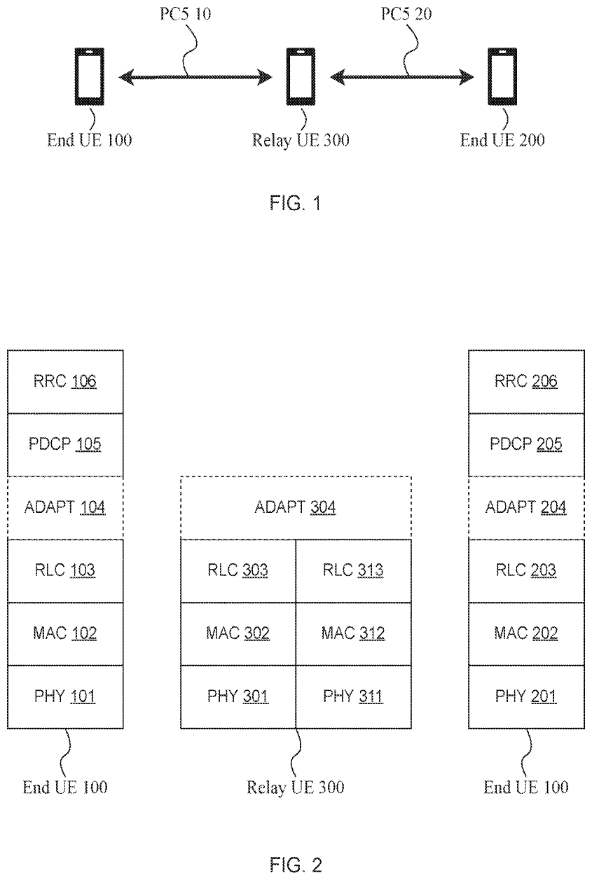

FIG. 1 is a schematic diagram illustrating an exemplary wireless communication system according to some embodiments of the present disclosure.

FIG. 1 shows a sidelink-based UE-to-UE relay. As shown in FIG. 1, an end UE 100 reaches an end UE 200 via an intermediate relay UE 300. The end UE 100 and the end UE 200 are in communication through a relay UE 300. According to the embodiment of FIG. 1, the end UEs 100 and 200 are in communication through only one relay UE 300. In some embodiments the end UEs 100 and 200 may be in communication through one or more relay UEs.

The end UE 100 and the relay UE 300 may communicate with each other through a PC5 link 10. The end UE 200 and the relay UE 300 may communication with each other through a PC5 link 20.

FIG. 2 is a schematic diagram illustrating exemplary protocol stack according to some embodiments of the present disclosure. FIG. 2 illustrates a protocol stack for the control plane of layer-2 UE-to-UE relay according to the some embodiments of the subject application. The adaptation (ADAPT) layer 104, radio link control (RLC) layer 103, media access control (MAC) layer 102, and physical (PHY) layer 101 of the end UE 100 and the ADAPT layer 304, RLC layer 303, MAC layer 302, and PHY layer 301 of the relay UE 300 are the protocols in charge of the communication of the hop between the end UE 100 and relay UE 300. The ADAPT layer 204, RLC layer 203, MAC layer 202, and PHY layer 201 of the end UE 200 and the ADAPT layer 304, RLC layer 313, MAC layer 312, and PHY layer 311 of the relay UE 300 are the protocols in charge of the communication of the hop between the end UE 200 and relay UE 300.

The radio resource control (RRC) layer 106 and the packet data convergence protocol (PDCP) layer 105 of the end UE 100 and the RRC layer 206 and the PDCP layer 205 of the end UE 200 are in charge of the end-to-end communication between the end UEs 100 and 200.

The ADAPT layer 104 may be put over RLC layer 103 for processing the data units received from the relay UE 300 and the data units transmitted to the relay UE 300. The ADAPT layer 204 may be put over RLC layer 203 for processing the data units received from the relay UE 300 and the data units transmitted to the relay UE 300. The ADAPT layer 304 may be put over RLC layers 303 for processing the data units received from the end UE 100 and the data units transmitted to the end UE 100. The ADAPT layer 304 may be put over RLC layers 313 for processing the data units received from the end UE 200 and the data units transmitted to the end UE 200.

In Release 17, criterion and procedure for relay selection (or reselection) and service continuity will be studied for sidelink-based layer-2 UE-to-UE relay communication.

For a layer-2 sidelink-based relay communication (e.g., a UE-to-UE relay communication), it could happen that an established multi-hop path fails due to broken intermediate relay. Then, the associated end UEs (e.g. source UE or target UE) may initiate a relay reselection procedure to find another path (direct path or multi-hop path) and resume the current data transmission and reception through the new path. During the relay reselection and path reestablishment, the current service may confront severe disturbance if the end UEs (e.g. source UE or target UE) discard the established end-to-end protocol stack and relevant context. On the other hand, end UEs may discard the established end-to-end protocol stack and relevant context completely if relay reselection fails (i.e. meaning no other available paths can be found).

The purpose of the sidelink RRC reconfiguration procedure is to modify a PC5-RRC connection, e.g. to establish/modify/release sidelink data radio bearers (DRBs), to configure NR sidelink measurement and report, and to configure sidelink channel state information (CSI) reference signal resources. An UE may initiate the sidelink RRC reconfiguration procedure and perform the operation on the corresponding PC5-RRC connection in following cases:
the release of sidelink DRBs associated with the peer UE;
the establishment of sidelink DRBs associated with the peer UE;
the modification for the parameters included in configurations of sidelink radio bearer (SLRB-Config) of sidelink DRBs associated with the peer UE;
the configuration of the peer UE to perform NR sidelink measurement and report; and
the configuration of the sidelink CSI reference signal resources.

In NR uplink (UL), downlink (DL), and PC5 link, the PDCP reestablishment and PDCP status report may be triggered.

For DRBs under acknowledge mode (AM) configured by upper layers to send a PDCP status report in the uplink (e.g., statusReportRequired in TS 38.331), the receiving PDCP entity shall trigger a PDCP status report when:
the upper layer requests a PDCP entity re-establishment;
the upper layer requests a PDCP data recovery;
the upper layer requests a uplink data switching; and
the upper layer reconfigures the PDCP entity to release DAPS (Dual Active Protocol Stack) and daps-SourceRelease (as configured in TS 38.331).

For DRBs under unacknowledge mode (UM) configured by upper layers to send a PDCP status report in the uplink (e.g., statusReportRequired in TS 38.331), the receiving PDCP entity shall trigger a PDCP status report when:
the upper layer requests a uplink data switching.

For DRBs under AM in the sidelink, the receiving PDCP entity shall trigger a PDCP status report when:
the upper layer requests a PDCP entity re-establishment.

In the present disclosure, methods and apparatuses to improve the service continuity for layer 2 sidelink-based relay are disclosed.

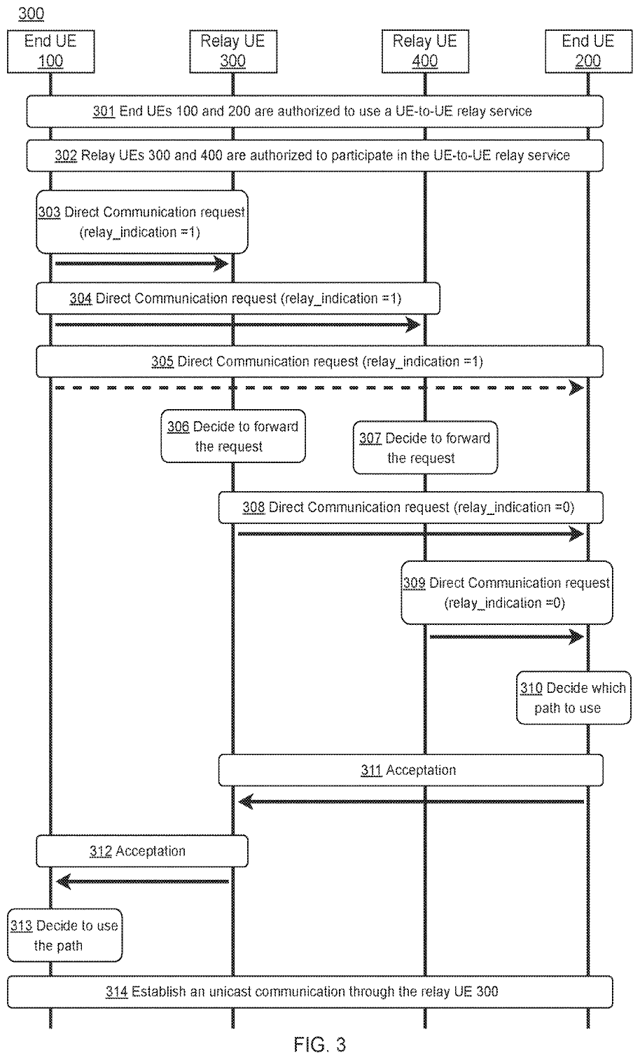

FIG. 3 is a flowchart of a method 300 for relay establishment according to some embodiments of the present disclosure. FIG. 3 shows an end UE 100, an end UE 200, a relay UE 300 and a relay 400.

In the present disclosure, an end UE may refer to a node generates the data or a node receives the data. An end UE may be either source UE or target UE. The UEs 100, 200, 300, and 400 of the present disclosure may be compatible with any type of network capable of sending and receiving wireless communication signals. For example, the UEs 100, 200, 300, and 400 of the present disclosure may be compatible with wireless communication, cellular telephone, time division multiple access (TDMA)-based, code division multiple access (CDMA)-based, orthogonal frequency division multiple access (OFDMA)-based, LTE, 3GPP-based, 3GPP 5G NR, satellite communications, high altitude platform, and/or other communications networks.

The UEs 100, 200, 300, and 400 of the present disclosure may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UEs 100, 200, 300, and 400 of the present disclosure may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UEs 100, 200, 300, and 400 may include wearable devices, such as smart watches, fitness bands, optical head-mounted displays, or the like. Moreover, the UEs 100, 200, 300, and 400 of the present disclosure may be referred to as a subscriber unit, a mobile, a mobile station, a user, a terminal, a mobile terminal, a wireless terminal, a fixed terminal, a subscriber station, a user terminal, or a device, or described using other terminology used in the art.

Referring to FIG. 3, in operation 301, the end UEs 100 and 200 may be authorized to use a service provided by the UE-to-UE relays (e.g., an UE-to-UE relay service). In operation 302, the relay UEs 300 and 400 may be authorized to provide service for the end UEs 100 and 200. In operation 302, the relay UEs 300 and 400 may be authorized to participate the UE-to-UE relay service of the end UEs 100 and 200. In operation 302, the relay UEs 300 and 400 may be authorized to provide service of relaying traffic between the end UEs 100 and 200.

The UE 100 requests to establish unicast communication link with the UE 200. The unicast communication link requested by the UE 100 may be through a direct link with the UE 200 or via a UE-to-UE relay. In operations 303, 304, and 305, the UE 100 may transmit or broadcast a direct communication request with relay_indication=1.

In operation 303, the direct communication request (with relay_indication=1) from the end UE 100 may be transmitted to the relay UE 300. In operation 304, the direct communication request (with relay_indication=1) from the end UE 100 may be transmitted to the relay UE 400. In operation 305, the direct communication request (with relay_indication=1) from the end UE 100 may fail to be transmitted to the end UE 200. In some embodiments, if the end UE 200 is in proximity to the end UE 100, the direct communication request (with relay_indication=1) may be transmitted to the end UE 200.

In operation 306, upon receipt of the direct communication request (with relay_indication=1), the relay UE 300 may subtract 1 from the “relay_indication” and decide to forward or broadcast the direct communication request (with relay_indication=0). If any relay device receives the request with relay_indication=0, the relay device will discard the request.

In operation 306, upon receipt of the direct communication request (with relay_indication=1), the relay UE 400 may subtract 1 from the “relay_indication” and decide to forward or broadcast the direct communication request (with relay_indication=0). If any relay device receives the request with relay_indication=0, the relay device will discard the request.

In operation 308, the direct communication request (with relay_indication=0) from the relay UE 300 may transmitted to the end UE 200. In operation 309, the direct communication request (with relay_indication=0) from the relay UE 400 may transmitted to the end UE 200.

In operation 310, upon receipt of the two direct communication requests (both with relay_indication=0) from the relay UEs 300 and 400, the end UE 200 may decide which path to be used. That is, the end UE 200 may decide whether the communication with the end UE 100 is established via the relay UE 300 or via the relay UE 400. The end UE 200 may make a decision based on some conditions associated with the candidate relay UEs and end UE, e.g., the battery levels, the channel states, the signal strength, the number of hops, the predetermined policies (e.g. always choose a direct path if it is possible), and etc. In some embodiments, if the end UE 200 directly receives the direct communication request from the end UE 100, the end UE 200 may decide to establish a direct communication link with the end UE 100 and transmit an acceptation message directly to the end UE 100.

In the embodiment of FIG. 3, the end UE 200 may decide to establish the communication link with the end UE 100 via the relay UE 200. In operation 311, the end UE 200 may transmit an acceptation message to the relay UE 300 to accept the direct communication request from the relay UE 300. In some embodiments, the response message from the end UE 200 (e.g., the acceptation message mentioned above) may include indication on the type of communication link being established (e.g. via relay or direct). In operation 312, the relay UE 300 may transmit or forward the acceptation message from the end UE 200 to the end UE 100.

In operation 313, upon receipt of one or more acceptation messages, the end UE 100 may decide which path to be used based on some conditions associated with the candidate relay UEs and end UE, e.g., the battery levels, the channel states, the signal strength, the number of hops, the predetermined policies (e.g. always choose a direct path if it is possible), and etc. In the embodiment of FIG. 3, there is only one acceptation message received by the end UE 100. Thus, the end UE 100 may choose to establish the communication link with the end UE 200 via the relay UE 300 in operation 313.

In operation 314, the end UEs 100 and 200 establish a unicast communication through the relay UE 300. The setup information for operation 314 may be different depending on the type of relay, e.g. Layer-2 or Layer-3 relaying. In some embodiments, if the end UE 100 receives the acceptation message directly from the end UE 200, the end UE 100 may choose to establish a direct communication link with the end UE 200 (e.g., a Layer-2 link), and operation 314 may be omitted.

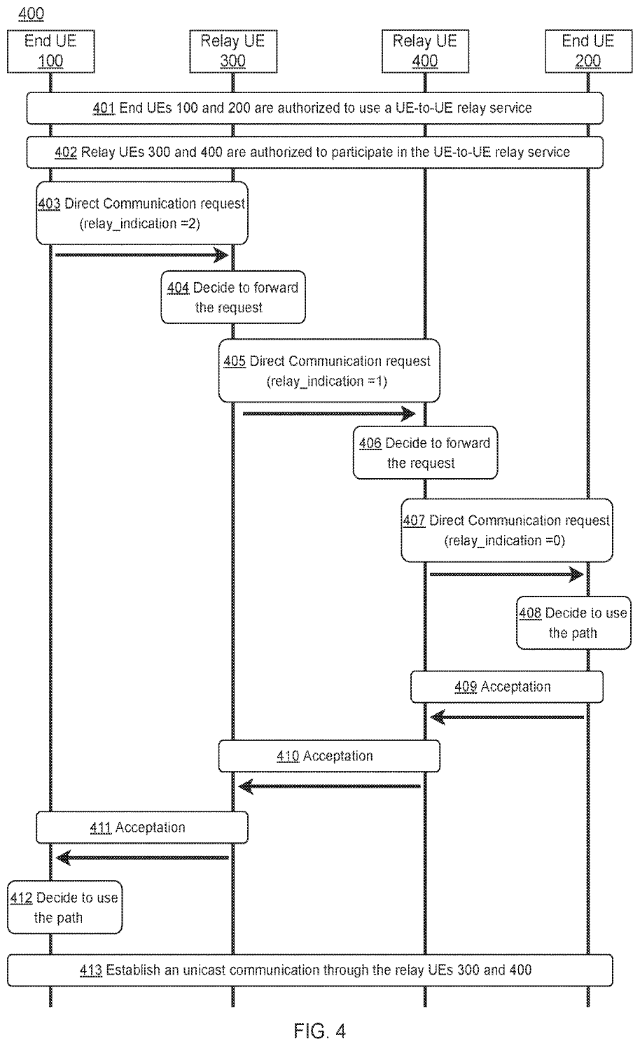

FIG. 4 is a flowchart of a method 400 for relay establishment according to some embodiments of the present disclosure. FIG. 4 shows an end UE 100, an end UE 200, a relay UE 300 and a relay 400.

Referring to FIG. 4, in operation 401, the end UEs 100 and 200 may be authorized to use a service provided by the UE-to-UE relays (e.g., an UE-to-UE relay service). In operation 402, the relay UEs 300 and 400 may be authorized to provide service for the end UEs 100 and 200. In operation 402, the relay UEs 300 and 400 may be authorized to participate the UE-to-UE relay service of the end UEs 100 and 200. In operation 402, the relay UEs 300 and 400 may be authorized to provide service of relaying traffic between the end UEs 100 and 200.

The UE 100 requests to establish unicast communication link with the UE 200. The unicast communication link requested by the UE 100 may be through a direct link with the UE 200 or via a UE-to-UE relay. In operation 403, the UE 100 may transmit or broadcast a direct communication request with relay_indication=2.

In operation 403, the direct communication request (with relay_indication=2) from the end UE 100 may be transmitted to the relay UE 300. In operation 404, upon receipt of the direct communication request (with relay_indication=2), the relay UE 300 may subtract 1 from the “relay_indication” and decide to forward or broadcast the direct communication request (with relay_indication=1).

In operation 405, the direct communication request (with relay_indication=1) from the relay UE 300 may be transmitted to the relay UE 400. In operation 406, upon receipt of the direct communication request (with relay_indication=1), the relay UE 400 may subtract 1 from the “relay_indication” and decide to forward or broadcast the direct communication request (with relay_indication=0). If any relay device receives the request with relay_indication=0, the relay device will discard the request.

In operation 407, the direct communication request (with relay_indication=0) from the relay UE 400 may be transmitted to the end UE 200. In some embodiments, if the end UE 200 is in proximity to the end UE 100, the direct communication request (with relay_indication=2) may be transmitted to the end UE 200.

In operation 408, upon receipt of one or more direct communication request from the relay UE or the end UE, the end UE 200 may decide which path to be used. In the embodiment of FIG. 4, there is only one direct communication request received by the end UE 200. Thus, the end UE 200 may choose to establish the communication link with the end UE 100 via the relay UEs 300 and 400 in operation 408. In some embodiments, the end UE 200 may make a decision based on some conditions associated with the candidate relay UEs and end UE, e.g., the battery levels, the channel states, the signal strength, the number of hops, the predetermined policies (e.g. always choose a direct path if it is possible), and etc. In some embodiments, if the end UE 200 directly receives the direct communication request from the end UE 100, the end UE 200 may decide to establish a direct communication link with the end UE 100 and transmit an acceptation message directly to the end UE 100.

In operation 409, the end UE 200 may transmit an acceptation message to the relay UE 400 to accept the direct communication request from the relay UE 400. In some embodiments, the response message from the end UE 200 (e.g., the acceptation message mentioned above) may include indication on the type of communication link being established (e.g. via relay or direct). In operation 410, the relay UE 400 may transmit or forward the acceptation message from the end UE 200 to the relay UE 300. In operation 411, the relay UE 300 may transmit or forward the acceptation message from the relay UE 300 to the end UE 100.

In operation 412, upon receipt of one or more acceptation messages, the end UE 100 may decide which path to be used based on some conditions associated with the candidate relay UEs and end UE, e.g., the battery levels, the channel states, the signal strength, the number of hops, the predetermined policies (e.g. always choose a direct path if it is possible), and etc. In the embodiment of FIG. 4, there is only one acceptation message received by the end UE 100. Thus, the end UE 100 may choose to establish the communication link with the end UE 200 via the relay UEs 300 and 400 in operation 412.

In operation 413, the end UEs 100 and 200 establish a unicast communication through the relay UE 300. The setup information for operation 314 may be different depending on the type of relay, e.g. Layer-2 or Layer-3 relaying. In some embodiments, if the end UE 100 receives the acceptation message directly from the end UE 200, the end UE 100 may choose to establish a direct communication link with the end UE 200 (e.g., a Layer-2 link), and operation 413 may be omitted.

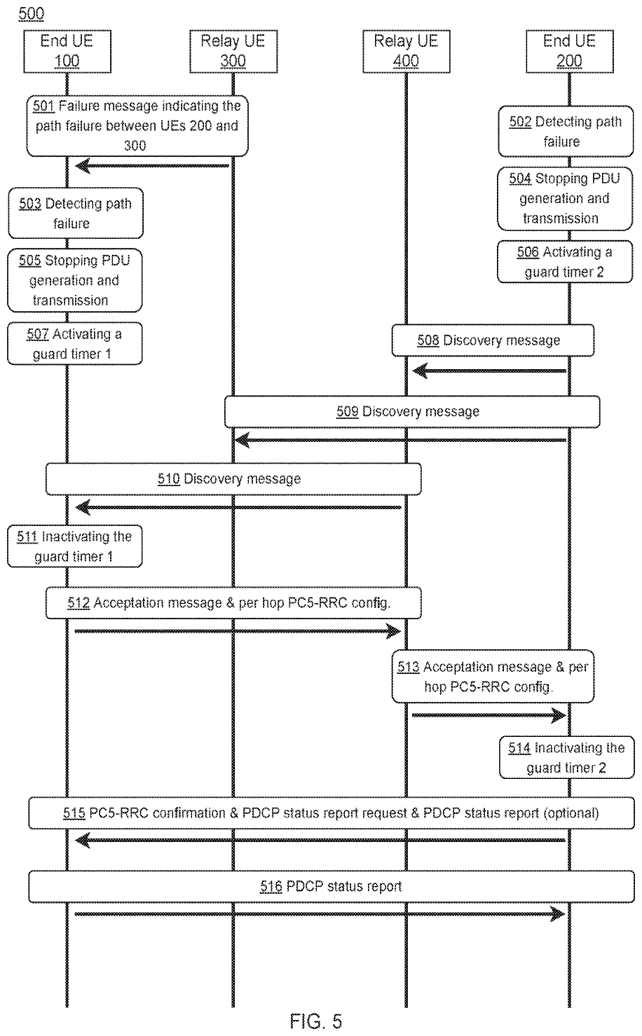

FIG. 5 is a flowchart of a method 500 for relay reselection according to some embodiments of the present disclosure. The method 500 may be an exemplary method for layer 2 UE-to-UE relay reselection. The method 500 considers service continuity enhancement. FIG. 5 shows an end UE 100, an end UE 200, a relay UE 300 and a relay 400.

In the method 500, when the end UEs (e.g. UEs 100 and 200 in FIG. 5) detects failure in the current multi-hop path (e.g. upon receiving a connection failure report from one of the intermediate relay UE or detecting the sidelink radio ling failure (RLF)), the end UEs may pause the current end-to-end protocol entity (e.g. RRC and PDCP entities) and start a guard timer. The end UEs may initiate relay reselection procedure and try to find another path reaching the counterpart UE. Upon finding the new path before the guard timer expires, the end UEs may resume the end-to-end protocol entity operation and transmit a PDCP status report to the counterpart UE to ensure packet lossless relay reselection. If the guard timer expires, the end UE may release the end-to-end protocol entity associated with the communication link (e.g., the current end-to-end PC5-RRC connection and RRC/PDCP entities).

Referring FIG. 5, a communication link has been established between the end UEs 100 and 200 through the relay UE 300. The relay UE 300 may detect failure of the path between the relay UE 300 and the end UE 200. The failure of the path may be caused by poor link quality or configuration failure. In operation 501, the relay UE 300 may transmit a failure message to the end UE 100 (the reachable end UE of the associated communication link). Such failure message may be a PC5-S (PC5-signaling) or PC5-RRC message generated by the relay UE 300. Such failure message may be sent through the existing LCH (logical channel) for the current multi-hop path so that the failure message will be further relayed until reaching the end UE.

In operation 502, the end UE 200 may detect failure in the current path to the end UE 100 is failed. The end UE 200 may detect the path failure by detecting the sidelink RLF. The end UE 200 may detect the path failure due to time-out. In operation 503, the end UE 100 may detect failure in the current path (e.g., a multi-hop path) upon receipt of a failure message from the relay UE 300.

Upon detection of path failure, the end UEs 100 and 200 may stop or pause the current end-to-end protocol entity (e.g. RRC and PDCP entities). In operation 504, the end UE 200 may stop to generate packet data units (PDUs) and stop to transmit PDUs upon detection of path failure. In operation 504, the end UE 200 may continue receiving PDUs from the relay UE 300 if any. In operation 505, the end UE 100 may stop to generate PDUs and stop to transmit PDUs upon detection of path failure. In operation 505, the end UE 100 may continue receiving PDUs from the relay UE 300 which are previously stored in the buffer of the relay UE 300.

In operation 506, the end UE 200 may activate or start a guard timer 2. Before the guard timer 2 expires, the end UE 200 may keep the associated end-to-end protocol entity (e.g. RRC and PDCP entities). In operation 507, the end UE 100 may activate or start a guard timer 1. Before the guard timer 1 expires, the end UE 100 may keep the associated end-to-end protocol entity (e.g. RRC and PDCP entities).

In the method 500, one or both of the end UEs 100 and 200 may transmit or broadcast a discovery message to reselect relay UEs. The discovery message may be transmitted or broadcasted through PC5-S. The discovery message may indicate the specific on-going end-to-end PC5 RRC connection of which this discovery message is used for the relay reselection. For example, the discovery message may indicate the specific on-going end-to-end PC5 RRC connection by application (APP) ID, Link ID, Layer-2 ID, or etc.

In the embodiment of FIG. 5, the end UE 200 may transmit or broadcast a discovery message. In operation 508, the discovery message transmitted or broadcasted by the end UE 200 may be received by the relay UE 400. In operation 509, the discovery message transmitted or broadcasted by the end UE 200 may be received by the relay UE 300.

The relay UE 300 may receive the discovery message transmitted or broadcasted by the end UE 200 through other relay device. The relay UE 300 may receive the discovery message transmitted or broadcasted by the end UE 200 due to temporarily available channel between the UEs 200 and 300. The relay UE 300, upon receipt of the discovery message transmitted or broadcasted by the end UE 200, may discard the discovery message because the path between the end UE 200 and the relay UE 300 was detected as failed. In some embodiments, the relay UE 300, upon receipt of the discovery message transmitted or broadcasted by the end UE 200, may discard the discovery message within a predetermined time period.

In other embodiments, the relay UE 300 may receive the discovery message transmitted or broadcasted by the end UE 100. The relay UE 300, upon receipt of the discovery message transmitted or broadcasted by the end UE 100, may discard the discovery message because the path between the end UE 200 and the relay UE 300 was detected as failed. In some embodiments, the relay UE 300, upon receipt of the discovery message transmitted or broadcasted by the end UE 100, may discard the discovery message within a predetermined time period.

The relay UE 400, upon receipt of the discovery message transmitted or broadcasted by the end UE 200, may transmit, forward, or broadcast the discovery message because the path between the end UE 200 and the relay UE 400 was detected as failed. In operation 510, the end UE 100 may receive the discovery message transmitted, forwarded, or broadcasted by the relay UE 400.

When the end UE 100 receives the discovery message for relay reselection originated from the end UE 200, if the guard time is not expired, the end UE 100 may stop or inactivate the guard timer 1. In operation 511, upon receipt of the discovery message originated from the end UE 200, the end UE 100 inactivates the guard timer 1.

When the end UE 100 receives the discovery message for relay reselection originated from the end UE 200, if the guard time is not expired, the end UE 100 may respond an “acceptation” message (which may be a PC5-S message) and initiate a RRC connection for the hop between itself and the device whom it receives the corresponding discovery message from. The acceptation message may indicate the specific on-going end-to-end PC5 RRC connection for which this acceptation message is (e.g., indicated by APP ID, Link ID, Layer-2 ID, and etc.).

In operation 512, the end UE 100 may transmit an acceptation message to the relay UE 400 responsive to the discovery message received from the relay UE 400. In operation 512, the PC5-RRC configuration for the PC5-RRC connection of the hop between the end UE 100 and the relay UE 400 is transmitted together with the acceptation message such that the PC5-RRC connection of this hop can be established.

When the relay UE 400 receives the acceptation message responsive to the discovery message that relay UE 400 was transmitted, the relay UE 400 may transmit or forward the acceptation to the device whom the relay UE 400 receives the corresponding discovery message. When the relay UE 400 receives the acceptation message responsive to the discovery message that relay UE 400 was transmitted, the relay UE 400 may initiate a RRC connection for the hop between itself and the device whom the relay UE 400 receives the corresponding discovery message. When the relay UE 400 receives the PC5-RRC configuration together with the acceptation message, the PC5-RRC connection of the hop between the UEs 100 and 400 may be established accordingly.

In the embodiment of FIG. 5, when the relay UE 400 receives the acceptation message responsive to the discovery message that relay UE 400 was transmitted, the relay UE 400 may transmit or forward the acceptation message to the end UE 200, in which the relay UE 400 receives the corresponding discovery message from the end UE 200. In the embodiment of FIG. 5, when the relay UE 400 receives the acceptation message responsive to the discovery message that relay UE 400 was transmitted, the relay UE 400 may initiate a RRC connection for the hop between the relay UE 400 and the end UE 200.

In operation 513, the relay UE 400 may transmit or forward the acceptation message to the end UE 200 responsive to the discovery message received from the end UE 200. In operation 513, the PC5-RRC configuration for the PC5-RRC connection of the hop between the relay UE 400 and the end UE 200 is transmitted together with the acceptation message such that the PC5-RRC connection of this hop can be established.

When the end UE 200 receives the PC5-RRC configuration together with the acceptation message, the PC5-RRC connection of the hop between the UEs 200 and 400 may be established accordingly. When the end UE 200 receives the acceptation message (for the relay reselection) originated from the end UE 100, if the guard timer is not expired, the end UE 200 may stop or inactivate the guard timer 1. In operation 514, upon receipt of the acceptation message originated from the end UE 100, the end UE 200 inactivates the guard timer 2.

The end-to-end RRC entity of the end UE 200 may generate a PC5-RRC confirmation message or a PC5-S confirmation message and transmit the same to the end UE 100 so as to confirm the finish of the relay reselection. In the PC5-RRC/PC5-S confirmation message, the end UE 200 may transmit a request for a PDCP status report from the end UE 100. In some embodiments, the end UE 100 may be triggered to transmit a PDCP status report to the end UE 200 upon the receipt of the PC5-RRC/PC5-S confirmation message from the end UE 200. The end UE 200 may generate a PDCP status report and transmit the same to the end UE 100 together with the PC5-RRC/PC5-S confirmation message. In operation 515, the end UE 200 may transmit a PC5-RRC confirmation message, a PDCT status report request, and a PDCP status report to the end UE 100.

Upon receipt of the PC5-RRC confirmation message from the end UE 200, the end UE 100 may generate a PDCP status report and transmit the same to the end UE 200. Upon receipt of the PC5-RRC confirmation message from the end UE 200, the end UE 100 may transmit a PC5-RRC message to request a PDCP status report from the end UE 200. In operation 516, the end UE 100 may transmit a PDCP status report to the end UE 200.

UE-to-UE relay is under study in release 17. The present disclosure improves the service continuity during relay reselection of a UE-to-UE relay communication. The present disclosure keeps the end-to-end PC5-RRC and PDCP context between the end UEs for a time period before releasing. PDCP status reports of the end US are transmitted after relay reselection finishes to ensure lossless packet delivery.

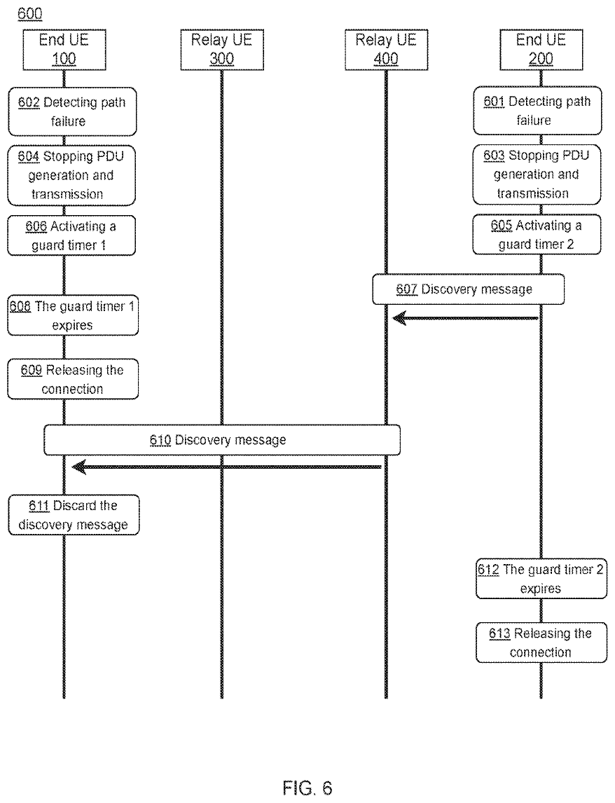

FIG. 6 is a flowchart of a method 600 for relay reselection according to some embodiments of the present disclosure. The method 600 may be an exemplary method for layer 2 UE-to-UE relay reselection. The method 600 considers service continuity enhancement. FIG. 6 shows an end UE 100, an end UE 200, a relay UE 300 and a relay 400.

In operation 601, the end UE 200 may detect failure in the current path to the end UE 100 is failed. In operation 602, the end UE 100 may detect failure in the current path to the end UE 200 is failed. The end UEs 100 and 200 may detect the path failure by detecting the sidelink RLF. The end UEs 100 and 200 may detect the path failure due to time-out.

Upon detection of path failure, the end UEs 100 and 200 may stop or pause the current end-to-end protocol entity (e.g. RRC and PDCP entities). In operation 603, the end UE 200 may stop to generate PDUs and stop to transmit PDUs upon detection of path failure. In operation 603, the end UE 200 may continue receiving PDUs from the previous relay device (e.g., the relay UE 300) if any. In operation 604, the end UE 100 may stop to generate PDUs and stop to transmit PDUs upon detection of path failure. In operation 604, the end UE 100 may continue receiving PDUs from the previous relay device (e.g., the relay UE 300) if any.

In operation 605, the end UE 200 may activate or start a guard timer 2. Before the guard timer 2 expires, the end UE 200 may keep the associated end-to-end protocol entity (e.g. RRC and PDCP entities). In operation 606, the end UE 100 may activate or start a guard timer 1. Before the guard timer 1 expires, the end UE 100 may keep the associated end-to-end protocol entity (e.g. RRC and PDCP entities).

In the method 600, one or both of the end UEs 100 and 200 may transmit or broadcast a discovery message to reselect relay UEs. The discovery message may be transmitted or broadcasted through PC5-S. The discovery message may indicate the specific on-going end-to-end PC5 RRC connection of which this discovery message is used for the relay reselection. For example, the discovery message may indicate the specific on-going end-to-end PC5 RRC connection by APP (application) ID, Link ID, Layer-2 ID, or etc.

In the embodiment of FIG. 6, the end UE 200 may transmit or broadcast a discovery message. In operation 607, the discovery message transmitted or broadcasted by the end UE 200 may be received by the relay UE 400.

In operation 608, the guard timer 1 of the end UE 100 may expires before receiving a discovery message. In operation 609, upon the expiration of the guard timer 1, the end UE 100 may release the associated end-to-end connection. For example, the end UE 100 may release the end-to-end protocol entity (e.g. RRC and PDCP entities) associated with the end UE 200.

In operation 610, the end UE 100 may receive the discovery message transmitted or broadcasted by the relay UE 400, in which the discovery message is originated from the end UE 200. In operation 611, because the guard timer 1 of the end UE 100 expires or because the associated protocol entity are released, the end UE 100 may ignore or discard the discovery message received from the relay UE 400. The end UE 100 may transmit nothing back to the relay UE 400 or the end UE 200.

In operation 612, the guard timer 2 of the end UE 200 may expire. The guard timer 2 of the end UE 200 may expire because it does receive nothing from the end UE 100 or any relay UEs. In operation 613, upon the expiration of the guard timer 2, the end UE 200 may release the end-to-end connection. For example, the end UE 200 may release the end-to-end protocol entity (e.g. RRC and PDCP entities) associated with the end UE 100. Regarding the relay UE 400, it may release or close the associated procedures due to time-out (because no relevant message is received).

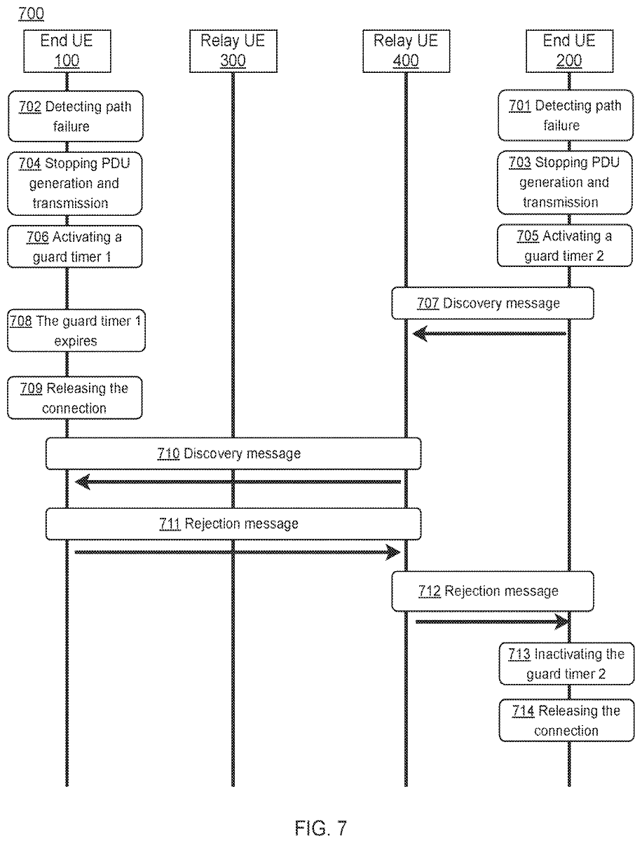

FIG. 7 is a flowchart of a method 700 for relay reselection according to some embodiments of the present disclosure. The method 700 may be an exemplary method for layer 2 UE-to-UE relay reselection. The method 700 considers service continuity enhancement. FIG. 7 shows an end UE 100, an end UE 200, a relay UE 300 and a relay 400.

In operation 701, the end UE 200 may detect failure in the current path to the end UE 100 is failed. In operation 702, the end UE 100 may detect failure in the current path to the end UE 200 is failed. The end UEs 100 and 200 may detect the path failure by detecting the sidelink RLF. The end UEs 100 and 200 may detect the path failure due to time-out.

Upon detection of path failure, the end UEs 100 and 200 may stop or pause the current end-to-end protocol entity (e.g. RRC and PDCP entities). In operation 703, the end UE 200 may stop to generate PDUs and stop to transmit PDUs upon detection of path failure. In operation 703, the end UE 200 may continue receiving PDUs from the previous relay device (e.g., the relay UE 300) if any. In operation 704, the end UE 100 may stop to generate PDUs and stop to transmit PDUs upon detection of path failure. In operation 704, the end UE 100 may continue receiving PDUs from the previous relay device (e.g., the relay UE 300) if any.

In operation 705, the end UE 200 may activate or start a guard timer 2. Before the guard timer 2 expires, the end UE 200 may keep the associated end-to-end protocol entity (e.g. RRC and PDCP entities). In operation 706, the end UE 100 may activate or start a guard timer 1. Before the guard timer 1 expires, the end UE 100 may keep the associated end-to-end protocol entity (e.g. RRC and PDCP entities).

In the method 700, one or both of the end UEs 100 and 200 may transmit or broadcast a discovery message to reselect relay UEs. The discovery message may be transmitted or broadcasted through PC5-S. The discovery message may indicate the specific on-going end-to-end PC5 RRC connection of which this discovery message is used for the relay reselection. For example, the discovery message may indicate the specific on-going end-to-end PC5 RRC connection by APP ID, Link ID, Layer-2 ID, or etc.

In the embodiment of FIG. 7, the end UE 200 may transmit or broadcast a discovery message. In operation 707, the discovery message transmitted or broadcasted by the end UE 200 may be received by the relay UE 400.

In operation 708, the guard timer 1 of the end UE 100 may expires before receiving a discovery message. In operation 709, upon the expiration of the guard timer 1, the end UE 100 may release the end-to-end connection. For example, the end UE 100 may release the end-to-end protocol entity (e.g. RRC and PDCP entities) associated with the end UE 200.

In operation 710, the end UE 100 may receive the discovery message transmitted or broadcasted by the relay UE 400, in which the discovery message is originated from the end UE 200. In operation 711, because the guard timer 1 of the end UE 100 expires or because the associated protocol entity are released, the end UE 100 may transmit a rejection message to the relay UE 400, whom the end UE 100 receives the discovery message from. The rejection message may be a PC5-S message. The rejection message may include some identifier (e.g., APP ID, Link ID, Layer-2 ID etc.), and the rejection message may indicate which connection (e.g., a PC5-RRC connection) and the associated protocol entity are released.

In operation 712, upon receipt the rejection message received from the end UE 100, the relay UE 400 may transmit or forward the rejection message to the end UE 200, whom the relay UE 400 receives the discovery message from. Additionally, after the rejection message is transmitted or forwarded, the relay UE 400 may release the associated procedures and end-to-end protocol entity (e.g. RRC and PDCP entities) based on the identifier in the rejection message.

In operation 713, upon receipt the rejection message received from the relay UE 400, the end UE 200 may inactivate the guard timer 2. In operation 714, upon receipt the rejection message received from the relay UE 400, the end UE 200 may release the associated end-to-end connection based on the identifier in the rejection message. For example, the end UE 200 may release the end-to-end protocol entity (e.g. RRC and PDCP entities) associated with the end UE 100.

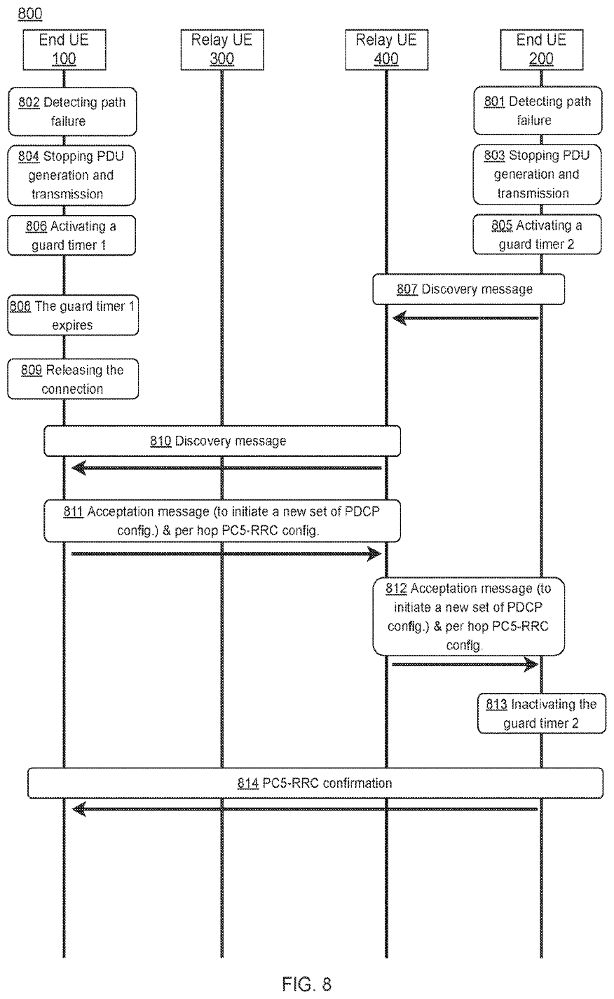

FIG. 8 is a flowchart of a method 800 for relay reselection according to some embodiments of the present disclosure. The method 800 may be an exemplary method for layer 2 UE-to-UE relay reselection. The method 800 considers service continuity enhancement. FIG. 8 shows an end UE 100, an end UE 200, a relay UE 300 and a relay 400.

In operation 801, the end UE 200 may detect failure in the current path to the end UE 100 is failed. In operation 802, the end UE 100 may detect failure in the current path to the end UE 200 is failed. The end UEs 100 and 200 may detect the path failure by detecting the sidelink RLF. The end UEs 100 and 200 may detect the path failure due to time-out.

Upon detection of path failure, the end UEs 100 and 200 may stop or pause the current end-to-end protocol entity (e.g. RRC and PDCP entities). In operation 803, the end UE 200 may stop to generate PDUs) and stop to transmit PDUs upon detection of path failure. In operation 803, the end UE 200 may continue receiving PDUs from the previous relay device (e.g., the relay UE 300) if any. In operation 804, the end UE 100 may stop to generate PDUs and stop to transmit PDUs upon detection of path failure. In operation 804, the end UE 100 may continue receiving PDUs from the previous relay device (e.g., the relay UE 300) if any.

In operation 805, the end UE 200 may activate or start a guard timer 2. Before the guard timer 2 expires, the end UE 200 may keep the associated end-to-end protocol entity (e.g. RRC and PDCP entities). In operation 806, the end UE 100 may activate or start a guard timer 1. Before the guard timer 1 expires, the end UE 100 may keep the associated end-to-end protocol entity (e.g. RRC and PDCP entities).

In the method 800, one or both of the end UEs 100 and 200 may transmit or broadcast a discovery message to reselect relay UEs. The discovery message may be transmitted or broadcasted through PC5-S. The discovery message may indicate the specific on-going end-to-end PC5 RRC connection of which this discovery message is used for the relay reselection. For example, the discovery message may indicate the specific on-going end-to-end PC5 RRC connection by APP ID, Link ID, Layer-2 ID, or etc.

In the embodiment of FIG. 8, the end UE 200 may transmit or broadcast a discovery message. In operation 807, the discovery message transmitted or broadcasted by the end UE 200 may be received by the relay UE 400.

In operation 808, the guard timer 1 of the end UE 100 may expires before receiving a discovery message. In operation 809, upon the expiration of the guard timer 1, the end UE 100 may release the end-to-end connection. For example, the end UE 100 may release the end-to-end protocol entity (e.g. RRC and PDCP entities) associated with the end UE 200.

In operation 810, the end UE 100 may receive the discovery message transmitted or broadcasted by the relay UE 400, in which the discovery message is originated from the end UE 200. In operation 811, because the guard timer 1 of the end UE 100 expires or because the associated protocol entity are released, the end UE 100 may transmit a acceptation message to the relay UE 400, whom the end UE 100 receives the discovery message from. The acceptation message may be a PC5-S message. In operation 811, together with the acceptation message, the end UE 100 may initiate a new sidelink RRC connection for the hop between the end UE 100 and the relay UE 400 through providing the associated configuration. In operation 811, together with the acceptation message, the end UE 100 may initiate a new set of PDCP configuration with the end UE 200 through the acceptation message.

Upon receipt of the acceptation message from the end UE 100, the relay UE 400 may set a new sidelink RRC connection for the hop between the end UE 100 and the relay UE 400. In operation 812, upon receipt of the acceptation message from the end UE 100, the rely UE 400 may transmit or forward the acceptation message from the end UE 100 to the end UE 200. In operation 812, together with the acceptation message, the relay UE 400 may initiate a new sidelink RRC connection for the hop between the relay UE 400 and the end UE 200 through providing the associated configuration. In operation 812, through the acceptation message, the end UE 100 may initiate a new set of PDCP configuration with the end UE 200.

In operation 813, upon receipt of the acceptation message originated from the end UE 100, the end UE 200 may inactivate the guard timer 2. The end UE 200 may initiate the new set of PDCP configuration according to the acceptation message. The end-to-end RRC entity of the end UE 200 may generate a PC5-RRC confirmation message or a PC5-S confirmation message and transmit the same to the end UE 100 so as to confirm the finish of the initiation of the new set of PDCP configuration between the end UEs 100 and 200. In operation 814, the end UE 200 may transmit a PC5-RRC confirmation message the end UE 100 so as to confirm the finish of the configuration based on the new set of PDCP configuration.

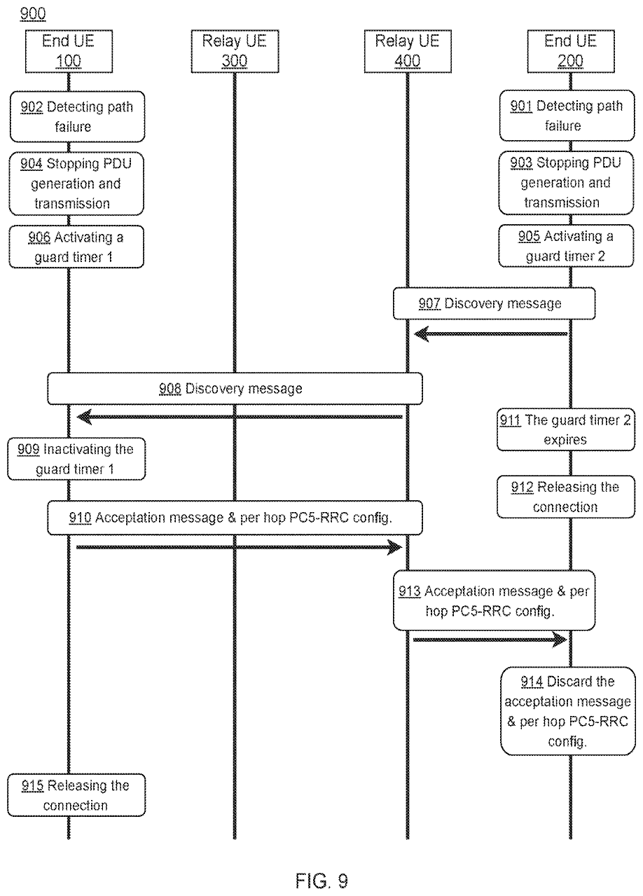

FIG. 9 is a flowchart of a method 900 for relay reselection according to some embodiments of the present disclosure. The method 900 may be an exemplary method for layer 2 UE-to-UE relay reselection. The method 900 considers service continuity enhancement. FIG. 9 shows an end UE 100, an end UE 200, a relay UE 300 and a relay 400.

In operation 901, the end UE 200 may detect failure in the current path to the end UE 100 is failed. In operation 902, the end UE 100 may detect failure in the current path to the end UE 200 is failed. The end UEs 100 and 200 may detect the path failure by detecting the sidelink RLF. The end UEs 100 and 200 may detect the path failure due to time-out.

Upon detection of path failure, the end UEs 100 and 200 may stop or pause the current end-to-end protocol entity (e.g. RRC and PDCP entities). In operation 903, the end UE 200 may stop to generate PDUs and stop to transmit PDUs upon detection of path failure. In operation 903, the end UE 200 may continue receiving PDUs from the previous relay device (e.g., the relay UE 300) if any. In operation 904, the end UE 100 may stop to generate PDUs and stop to transmit PDUs upon detection of path failure. In operation 904, the end UE 100 may continue receiving PDUs from the previous relay device (e.g., the relay UE 300) if any.

In operation 905, the end UE 200 may activate or start a guard timer 2. Before the guard timer 2 expires, the end UE 200 may keep the associated end-to-end protocol entity (e.g. RRC and PDCP entities). In operation 906, the end UE 100 may activate or start a guard timer 1. Before the guard timer 1 expires, the end UE 100 may keep the associated end-to-end protocol entity (e.g. RRC and PDCP entities).

In the method 900, one or both of the end UEs 100 and 200 may transmit or broadcast a discovery message to reselect relay UEs. The discovery message may be transmitted or broadcasted through PC5-S. The discovery message may indicate the specific on-going end-to-end PC5 RRC connection of which this discovery message is used for the relay reselection. For example, the discovery message may indicate the specific on-going end-to-end PC5 RRC connection by APP ID, Link ID, Layer-2 ID, or etc.

In the embodiment of FIG. 9, the end UE 200 may transmit or broadcast a discovery message. In operation 907, the discovery message transmitted or broadcasted by the end UE 200 may be received by the relay UE 400.

The relay UE 400, upon receipt of the discovery message transmitted or broadcasted by the end UE 200, may transmit, forward, or broadcast the discovery message. In operation 908, the end UE 100 may receive the discovery message transmitted, forwarded, or broadcasted by the relay UE 400.

When the end UE 100 receives the discovery message for relay reselection originated from the end UE 200, if the guard time is not expired, the end UE 100 may stop or inactivate the guard timer 1. In operation 909, upon receipt of the discovery message originated from the end UE 200, the end UE 100 inactivates the guard timer 1.

When the end UE 100 receives the discovery message for relay reselection originated from the end UE 200, if the guard time is not expired, the end UE 100 may respond an “acceptation” message (which may be a PC5-S message) and initiate a RRC connection for the hop between itself and the device whom it receives the corresponding discovery message from. The acceptation message may indicate the specific on-going end-to-end PC5 RRC connection for which this acceptation message is (e.g., indicated by APP ID, Link ID, Layer-2 ID, and etc.).

In operation 910, the end UE 100 may transmit an acceptation message to the relay UE 400 responsive to the discovery message received from the relay UE 400. In operation 910, the PC5-RRC configuration for the PC5-RRC connection of the hop between the end UE 100 and the relay UE 400 is transmitted together with the acceptation message such that the PC5-RRC connection of this hop can be established.

In operation 911, the guard timer 2 of the end UE 200 may expires before receiving an acceptation message. In operation 912, upon the expiration of the guard timer 2, the end UE 200 may release the associated end-to-end connection. For example, the end UE 200 may release the end-to-end protocol entity (e.g. RRC and PDCP entities) associated with the end UE 100.

In operation 913, the relay UE 400 may transmit or forward the acceptation message to the end UE 200 responsive to the discovery message received from the end UE 200. In operation 913, the PC5-RRC configuration for the PC5-RRC connection of the hop between the relay UE 400 and the end UE 200 is transmitted together with the acceptation message such that the PC5-RRC connection of this hop can be established.

In operation 914, because the guard timer 2 of the end UE 200 expires or because the associated protocol entity are released, the end UE 200 may ignore or discard the acceptation message and the PC5-RRC configuration from the relay UE 400. The end UE 200 may transmit nothing to the relay UE 400 or the end UE 100.

Because the end UE 100 does not receive anything from the relay UE 400 or the end UE 200, the end UE 100 may release the associated end-to-end connection due to time-out. In operation 915, the end UE 100 may release the associated end-to-end connection due to time-out. For example, the end UE 100 may release the end-to-end protocol entity (e.g. RRC and PDCP entities) associated with the end UE 200.

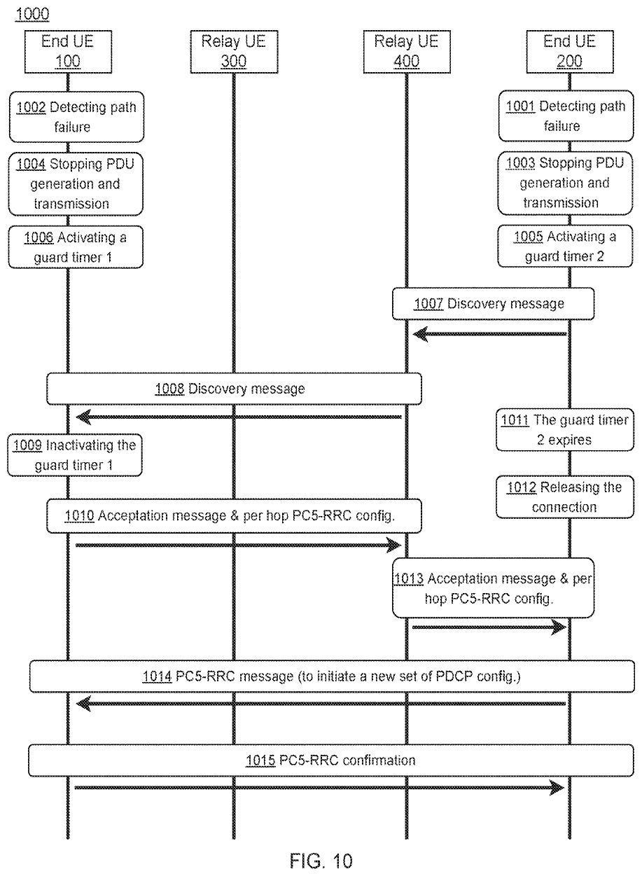

FIG. 10 is a flowchart of a method 1000 for relay reselection according to some embodiments of the present disclosure. The method 1000 may be an exemplary method for layer 2 UE-to-UE relay reselection. The method 1000 considers service continuity enhancement. FIG. 10 shows an end UE 100, an end UE 200, a relay UE 300 and a relay 400.

In operation 1001, the end UE 200 may detect failure in the current path to the end UE 100 is failed. In operation 1002, the end UE 100 may detect failure in the current path to the end UE 200 is failed. The end UEs 100 and 200 may detect the path failure by detecting the sidelink RLF. The end UEs 100 and 200 may detect the path failure due to time-out.

Upon detection of path failure, the end UEs 100 and 200 may stop or pause the current end-to-end protocol entity (e.g. RRC and PDCP entities). In operation 1003, the end UE 200 may stop to generate PDUs and stop to transmit PDUs upon detection of path failure. In operation 1003, the end UE 200 may continue receiving PDUs from the previous relay device (e.g., the relay UE 300) if any. In operation 1004, the end UE 100 may stop to generate PDUs and stop to transmit PDUs upon detection of path failure. In operation 1004, the end UE 100 may continue receiving PDUs from the previous relay device (e.g., the relay UE 300) if any.

In operation 1005, the end UE 200 may activate or start a guard timer 2. Before the guard timer 2 expires, the end UE 200 may keep the associated end-to-end protocol entity (e.g. RRC and PDCP entities). In operation 1006, the end UE 100 may activate or start a guard timer 1. Before the guard timer 1 expires, the end UE 100 may keep the associated end-to-end protocol entity (e.g. RRC and PDCP entities).

In the method 1000, one or both of the end UEs 100 and 200 may transmit or broadcast a discovery message to reselect relay UEs. The discovery message may be transmitted or broadcasted through PC5-S. The discovery message may indicate the specific on-going end-to-end PC5 RRC connection of which this discovery message is used for the relay reselection. For example, the discovery message may indicate the specific on-going end-to-end PC5 RRC connection by APP ID, Link ID, Layer-2 ID, or etc.

In the embodiment of FIG. 10, the end UE 200 may transmit or broadcast a discovery message. In operation 1007, the discovery message transmitted or broadcasted by the end UE 200 may be received by the relay UE 400.

The relay UE 400, upon receipt of the discovery message transmitted or broadcasted by the end UE 200, may transmit, forward, or broadcast the discovery message. In operation 1008, the end UE 100 may receive the discovery message transmitted, forwarded, or broadcasted by the relay UE 400.

When the end UE 100 receives the discovery message for relay reselection originated from the end UE 200, if the guard time is not expired, the end UE 100 may stop or inactivate the guard timer 1. In operation 1009, upon receipt of the discovery message originated from the end UE 200, the end UE 100 inactivates the guard timer 1.

When the end UE 100 receives the discovery message for relay reselection originated from the end UE 200, if the guard time is not expired, the end UE 100 may respond an “acceptation” message (which may be a PC5-S message) and initiate a RRC connection for the hop between itself and the device whom it receives the corresponding discovery message from. The acceptation message may indicate the specific on-going end-to-end PC5 RRC connection for which this acceptation message is (e.g., indicated by APP ID, Link ID, Layer-2 ID, and etc.).

In operation 1010, the end UE 100 may transmit an acceptation message to the relay UE 400 responsive to the discovery message received from the relay UE 400. In operation 1010, the PC5-RRC configuration for the PC5-RRC connection of the hop between the end UE 100 and the relay UE 400 is transmitted together with the acceptation message such that the PC5-RRC connection of this hop can be established.

In operation 1011, the guard timer 2 of the end UE 200 may expires before receiving an acceptation message. In operation 1012, upon the expiration of the guard timer 2, the end UE 200 may release the associated end-to-end connection. For example, the end UE 200 may release the end-to-end protocol entity (e.g. RRC and PDCP entities) associated with the end UE 100.

In operation 1013, the relay UE 400 may transmit or forward the acceptation message to the end UE 200 responsive to the discovery message received from the end UE 200. In operation 1013, the PC5-RRC configuration for the PC5-RRC connection of the hop between the relay UE 400 and the end UE 200 is transmitted together with the acceptation message such that the PC5-RRC connection of this hop can be established.

Upon receipt of the acceptation message and the PC5-RRC configuration, the end UE 200 may establish an PC5-RRC connection of the hop between the relay UE 400 and the end UE 200. In operation 1014, because the guard timer 2 of the end UE 200 expires or because the associated protocol entity are released, the end-to-end RRC entity of the end UE 200 may generate a PC5-RRC message and transmit the same to the end UE 100 with a end-to-end communication link so as to set a new PC5-RRC connection with the end UE 100.

Upon receipt of the PC5-RRC message originated from the end UE 200, the end UE 100 may initiate the new set of PDCP configuration accordingly. The end-to-end RRC entity of the end UE 100 may generate a PC5-RRC message or a PC5-S message and transmit the same to the end UE 100 so as to confirm the finish of the initiation of the new set of PDCP configuration between the end UEs 100 and 200. In operation 1015, the end UE 100 may transmit a PC5-RRC confirmation message the end UE 200 so as to confirm the finish of the configuration based on the new set of PDCP configuration.

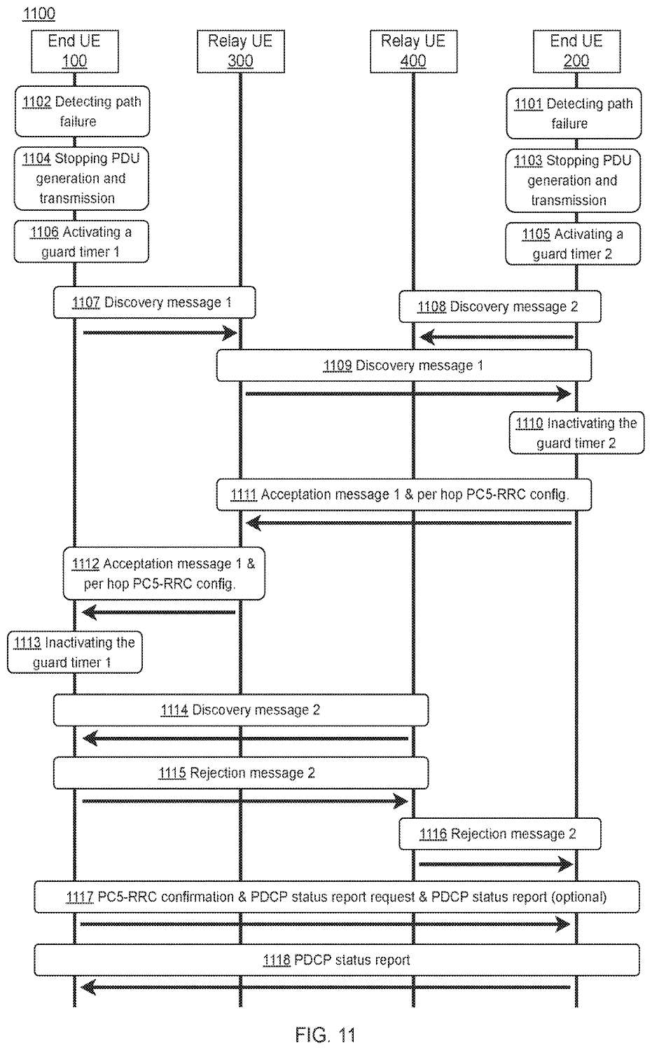

FIG. 11 is a flowchart of a method 1100 for relay reselection according to some embodiments of the present disclosure. The method 1100 may be an exemplary method for layer 2 UE-to-UE relay reselection. The method 1100 considers service continuity enhancement. FIG. 11 shows an end UE 100, an end UE 200, a relay UE 300 and a relay 400.

In operation 1101, the end UE 200 may detect failure in the current path to the end UE 100 is failed. In operation 1102, the end UE 100 may detect failure in the current path to the end UE 200 is failed. The end UEs 100 and 200 may detect the path failure by detecting the sidelink RLF. The end UEs 100 and 200 may detect the path failure due to time-out.

Upon detection of path failure, the end UEs 100 and 200 may stop or pause the current end-to-end protocol entity (e.g. RRC and PDCP entities). In operation 1103, the end UE 200 may stop to generate PDUs and stop to transmit PDUs upon detection of path failure. In operation 1103, the end UE 200 may continue receiving PDUs from the previous relay device if any. In operation 1104, the end UE 100 may stop to generate PDUs and stop to transmit PDUs upon detection of path failure. In operation 1104, the end UE 100 may continue receiving PDUs from the previous relay device if any.

In operation 1105, the end UE 200 may activate or start a guard timer 2. Before the guard timer 2 expires, the end UE 200 may keep the associated end-to-end protocol entity (e.g. RRC and PDCP entities). In operation 1106, the end UE 100 may activate or start a guard timer 1. Before the guard timer 1 expires, the end UE 100 may keep the associated end-to-end protocol entity (e.g. RRC and PDCP entities).

In the embodiment of FIG. 11, both the end UEs 100 and 200 may transmit or broadcast a discovery message to reselect relay UEs. The discovery message may be transmitted or broadcasted through PC5-S. The discovery message may indicate the specific on-going end-to-end PC5 RRC connection of which this discovery message is used for the relay reselection. For example, the discovery message may indicate the specific on-going end-to-end PC5 RRC connection by APP (application) ID, Link ID, Layer-2 ID, or etc. In operation 1107, the end UE 100 may transmit or broadcast a discovery message 1. In operation 1108, the end UE 200 may transmit or broadcast a discovery message 2.

The relay UE 300, upon receipt of the discovery message transmitted or broadcasted by the end UE 100, may transmit, forward, or broadcast the discovery message 1. In operation 1109, the end UE 200 may receive the discovery message transmitted, forwarded, or broadcasted by the relay UE 300.

When the end UE 200 receives the discovery message for relay reselection originated from the end UE 100, since the guard time 2 is not expired, the end UE 200 may stop or inactivate the guard timer 2. In operation 1110, upon receipt of the discovery message originated from the end UE 100, the end UE 200 inactivates the guard timer 2.

When the end UE 200 receives the discovery message for relay reselection originated from the end UE 100, since the guard time is not expired, the end UE 200 may respond an “acceptation” message (which may be a PC5-S message) and initiate a RRC connection for the hop between itself and the device whom it receives the corresponding discovery message from. The acceptation message may indicate the specific on-going end-to-end PC5 RRC connection for which this acceptation message is (e.g., indicated by APP ID, Link ID, Layer-2 ID, and etc.).

In operation 1111, the end UE 200 may transmit an acceptation message 1 to the relay UE 300 responsive to the discovery message received from the relay UE 300. In operation 1111, the PC5-RRC configuration for the PC5-RRC connection of the hop between the end UE 100 and the relay UE 300 is transmitted together with the acceptation message 1 such that the PC5-RRC connection of this hop can be established.

When the relay UE 300 receives the acceptation message 1 responsive to the discovery message that relay UE 300 was transmitted, the relay UE 300 may transmit or forward the acceptation message 1 to the end UE 100, in which the relay UE 300 receives the corresponding discovery message from the end UE 100. When the relay UE 300 receives the acceptation message 1 responsive to the discovery message that relay UE 300 was transmitted, the relay UE 300 may initiate a RRC connection for the hop between the relay UE 300 and the end UE 100.

In operation 1112, the relay UE 300 may transmit or forward the acceptation message 1 to the end UE 100 responsive to the discovery message received from the end UE 100. In operation 1112, the PC5-RRC configuration for the PC5-RRC connection of the hop between the relay UE 300 and the end UE 100 is transmitted together with the acceptation message 1 such that the PC5-RRC connection of this hop can be established.

When the end UE 100 receives the PC5-RRC configuration together with the acceptation message 1, the PC5-RRC connection of the hop between the UEs 100 and 300 may be established accordingly. When the end UE 100 receives the acceptation message 1 (for the relay reselection) originated from the end UE 200, since the guard timer 1 is not expired, the end UE 100 may stop or inactivate the guard timer 1. In operation 1113, upon receipt of the acceptation message originated from the end UE 100, the end UE 200 inactivates the guard timer 2.

The relay UE 300, upon receipt of the discovery message transmitted or broadcasted by the end UE 200, may transmit, forward, or broadcast the discovery message 2. In operation 1114, the end UE 100 may receive the discovery message transmitted, forwarded, or broadcasted by the relay UE 400.

Upon receipt of the discovery message 2 from the relay UE 400, the end UE 100 may identify the discovery message 2 is associated with the specific on-going end-to-end PC5 RRC connection. Therefore, the end UE 100 may regard the discovery message 2 as redundant since the end UE 100 already receives another discovery message associated with the same end-to-end PC5 RRC connection (i.e., the discovery message 1) and already inactivate the guard timer (i.e., the guard timer 1) associated with the same end-to-end PC5 RRC connection. In operation 1115, the end UE 100 may transmit a rejection message 2 to the relay UE 400, whom the end UE 100 receives the discovery message 2 from. The rejection message 2 may be a PC5-S message. The rejection message 2 responsive to the discovery message 2 may indicate that relay reselection for the same end-to-end PC5 RRC connection is being processed.

Upon receipt of the rejection message 2, the relay UE 400 may transmit or forward the rejection message 2 to the end UE 200, from which the relay UE 400 receives the corresponding discovery message 2. In operation 1116, the relay UE 400 may transmit or forward the rejection message 2 to the end UE 200.

Upon receipt acceptation message originated from the end UE 200, the end-to-end RRC entity of the end UE 100 may generate a PC5-RRC confirmation message or a PC5-S confirmation message and transmit the same to the end UE 200 so as to confirm the finish of the relay reselection. In the PC5-RRC/PC5-S confirmation message, the end UE 100 may transmit a request for a PDCP status report from the end UE 200. The end UE 100 may generate a PDCP status report and transmit the same to the end UE 300 together with the PC5-RRC/PC5-S confirmation message. In operation 1117, the end UE 100 may transmit a PC5-RRC confirmation message, a PDCT status report request, and a PDCP status report to the end UE 200. In operation 1118, the end UE 200 may transmit a PDCP status report to the end UE 100.

In some embodiments, the rejection message 2 in operation 1115 may be transmitted by the end UE 100 after operation 1117. In the embodiments, operations 1115 and 1116 may be performed after operation 1117.

In some embodiments, the end UE 100 may ignore or discard the discovery message 2 and may transmit nothing back. The relay UEs associated with the discovery message 2 and the end UE 200 may release the procedures associated with the discovery message 2 due to time-out.

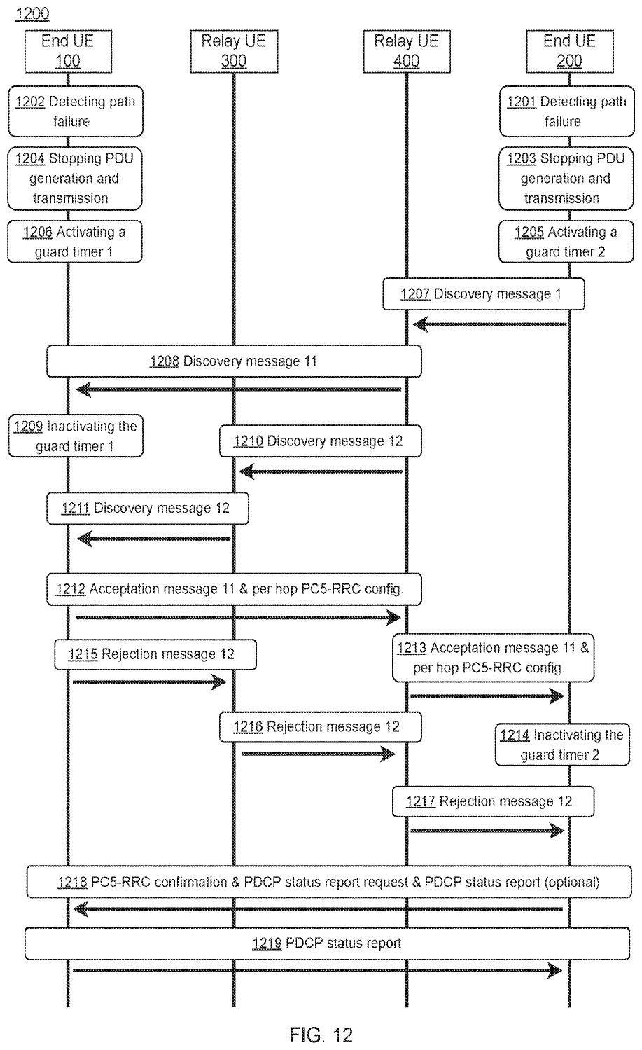

FIG. 12 is a flowchart of a method 1200 for relay reselection according to some embodiments of the present disclosure. The method 1200 may be an exemplary method for layer 2 UE-to-UE relay reselection. The method 1100 considers service continuity enhancement. FIG. 12 shows an end UE 100, an end UE 200, a relay UE 300 and a relay 400.

In operation 1201, the end UE 200 may detect failure in the current path to the end UE 100 is failed. In operation 1202, the end UE 100 may detect failure in the current path to the end UE 200 is failed.

Upon detection of path failure, the end UEs 100 and 200 may stop or pause the current end-to-end protocol entity (e.g. RRC and PDCP entities). In operation 1203, the end UE 200 may stop to generate PDUs and stop to transmit PDUs upon detection of path failure. In operation 1203, the end UE 200 may continue receiving PDUs from the previous relay device if any. In operation 1204, the end UE 100 may stop to generate PDUs and stop to transmit PDUs upon detection of path failure. In operation 1204, the end UE 100 may continue receiving PDUs from the previous relay device if any.

In operation 1205, the end UE 200 may activate or start a guard timer 2. Before the guard timer 2 expires, the end UE 200 may keep the associated end-to-end protocol entity (e.g. RRC and PDCP entities). In operation 1206, the end UE 100 may activate or start a guard timer 1. Before the guard timer 1 expires, the end UE 100 may keep the associated end-to-end protocol entity (e.g. RRC and PDCP entities).

In the embodiment of FIG. 12, the end UE 200 may transmit or broadcast a discovery message (i.e., the discovery message 1) to reselect relay UEs. The discovery message may be transmitted or broadcasted through PC5-S. The discovery message may indicate the specific on-going end-to-end PC5 RRC connection of which this discovery message is used for the relay reselection. For example, the discovery message may indicate the specific on-going end-to-end PC5 RRC connection by APP ID, Link ID, Layer-2 ID, or etc. In operation 1207, the end UE 200 may transmit or broadcast a discovery message 2.

The relay UE 400, upon receipt of the discovery message transmitted or broadcasted by the end UE 100, may transmit, forward, or broadcast the discovery message 1. In operation 1208, the end UE 100 may receive the discovery message 11 transmitted or broadcasted by the relay UE 400.

When the end UE 100 receives the discovery message 11 for relay reselection originated from the end UE 200, since the guard time 1 is not expired, the end UE 100 may stop or inactivate the guard timer 1. In operation 1209, upon receipt of the discovery message originated from the end UE 200, the end UE 100 inactivates the guard timer 1.

In operation 1210, the relay UE 300 may receive the discovery message 12 transmitted or broadcasted by the relay UE 400. In operation 1211, the end UE 100 may receive the discovery message 12 transmitted or broadcasted by the relay UE 300.

Upon receipt of multiple discovery messages, the end UE 100 may select a path based on some conditions associated with the candidate relay UEs and end UE, e.g., the battery levels, the channel states, the signal strength, the number of hops, the predetermined policies (e.g. always choose a direct path if it is possible), and etc. In some embodiments, the end UE 100 may accept the first arrived discovery message (i.e., discovery message 11) and reject the other discovery messages (i.e., discovery message 12).

In the embodiment of FIG. 12, the end UE 100 may decide to transmit an acceptation message (i.e., acceptation message 11) in response to the discovery message 11 and initiate a RRC connection for the hop between the end UE 100 and the relay UE 400. In operation 1212, the end UE 100 may transmit an acceptation message 11 to the relay UE 400 responsive to the discovery message 11. In operation 1212, the PC5-RRC configuration for the PC5-RRC connection of the hop between the end UE 100 and the relay UE 400 is transmitted together with the acceptation message 11 such that the PC5-RRC connection of this hop can be established.

In operation 1213, when the relay UE 300 receives the acceptation message 11 responsive to the discovery message 11, the relay UE 300 may transmit or forward the acceptation message 11 to the end UE 200 responsive to the discovery message received from the end UE 200. In operation 1213, the PC5-RRC configuration for the PC5-RRC connection of the hop between the relay UE 400 and the end UE 200 is transmitted together with the acceptation message 11 such that the PC5-RRC connection of this hop can be established. In operation 1214, upon receipt of the acceptation message originated from the end UE 100, the end UE 200 inactivates the guard timer 2.

In the embodiment of FIG. 12, the end UE 100 may decide to transmit a rejection message (i.e., rejection message 12) in response to the discovery message 12. In operation 1215, the end UE 100 may transmit a rejection message 12 to the relay UE 300. The rejection message 12 may be a PC5-S message. The rejection message 12 responsive to the discovery message 12 may indicate that relay reselection for the same end-to-end PC5 RRC connection is being processed. In operation 1216, the rejection message 12 may be transmit or forwarded from the relay UE 300 to the relay UE 400. In operation 1217, the rejection 12 may be transmitted or forwarded from the relay UE 400 to the end UE 200.

In operation 1218, the end UE 200 may transmit a PC5-RRC confirmation message, a PDCT status report request, and a PDCP status report to the end UE 100. In operation 1219, the end UE 100 may transmit a PDCP status report to the end UE 200.

In some embodiments, the rejection message 12 in operation 1215 may be transmitted by the end UE 100 after operation 1218. In the embodiments, operations 1215, 1216, and 1217 may be performed after operation 1218.

In some embodiments, the end UE 100 may ignore or discard the discovery message 12 and may transmit nothing back. The relay UEs associated with the discovery message 12 and the end UE 200 may release the procedures associated with the discovery message 12 due to time-out.

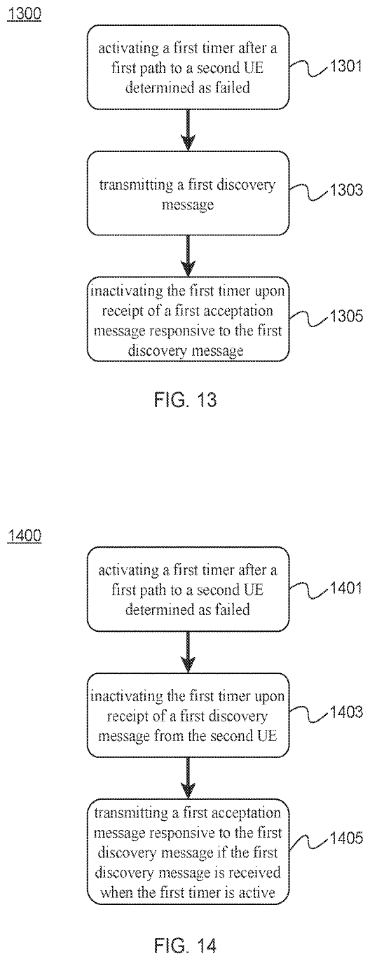

FIG. 13 is a flowchart of a method 1300 according to some embodiments of the present disclosure. The method 1300 may be performed by a first UE. In some embodiments, the first UE may be the end UE 100 or 200. The first UE may be one of the end UEs 100 and 200 which transmits a discovery message.

In operation 1301 of the exemplary method 1300 shown in FIG. 13, the first UE may activate or start a first timer after a first path to a second UE determined as failed. The first timer may be a guard timer. The second UE may be one of the end UEs 100 and 200.

In operation 1303, the first UE may transmit a first discovery message. In operation 1305, the first UE may inactivate or stop the first timer upon receipt of a first acceptation message. The first acceptation is responsive to the first discovery message. In some embodiments, the first timer may inactivate or stop upon receipt of a first acceptation message if the first timer does not expire.

In some embodiments of the method 1300, the first UE may release a connection to the second UE when the first timer expires. The connection to the second UE may be released by discarding end-to-end RRC connection context and PDCP configurations (e.g. RRC and PDCP entities) associated with the second UE. The first timer may expire because no corresponding acceptation message is received.

In some embodiments of the method 1300, the first discovery message may include an identifier associated with the first UE and the second UE. The first discovery message may include an identifier associated with the end-to-end connection between the first UE and the second UE. The identifier may indicate that such discovery message is for relay reselection of an on-going end-to-end PC5 RRC connection. The identifier may be one or more of APP ID, Link ID, Layer-2 ID, and etc.

In some embodiments of the method 1300, the first path may be determined as failed because of time out. The first UE may determine the first path as failed because the first UE does not receive any subsequent data units from the opposite end UE. The first UE may determine the first path as failed because the first UE does not receive any feedback responsive to the previous data units transmitted to the opposite end UE. In some embodiments of the method 1300, the first path may be determined as failed upon receipt of a failure message from a third UE. The third UE may transmit a failure message to an end UE and indicate that the other end UE is not reachable for the third UE. The third UE may be a relay UE.

In some embodiments of the method 1300, after the first path to the second UE is determined as failed, the first UE may stop generating data units for the second UE and/or stop transmitting data units to the second UE.

In some embodiments, the method 1300 may further comprise receiving a first hop configuration from a fourth UE, wherein the first acceptation message is transmitted by the second UE through the fourth UE. The first hop configuration may be PC5-RRC configurations for the hop between the first and fourth UEs. The fourth UE may be a relay UE.

In some embodiments, the method 1300 may further comprise transmitting an establishment confirmation to the second UE. The establishment confirmation may be an end-to-end confirmation in a PC5-RRC message or a PC5-S message. A first status report (e.g., a PDCP status report) is transmitted with the establishment confirmation. The method 1300 may further comprise receiving a second status report (e.g., a PDCP status report) from the second UE. A request for the second status report may be transmitted with the establishment confirmation.

In some embodiments, if a packet data convergence protocol (PDCP) configuration is received with the first acceptation message, the method 1300 may further comprises establishing a connection to the second UE based on the PDCP configuration.

In some embodiments, the method 1300 may further comprise discarding or ignoring the first acceptation message if the first acceptation message is received when the first timer expires.

In some embodiments, the method 1300 may further comprise receiving a first rejection message from the second UE responsive to the first discovery message; and releasing a connection to the second UE. The connection to the second UE may be released by discarding end-to-end RRC connection context and PDCP configurations (e.g. RRC and PDCP entities) associated with the second UE.

FIG. 14 is a flowchart of a method 1400 according to some embodiments of the present disclosure. The method 1400 may be performed by a first UE. In some embodiments, the first UE may be the end UE 100 or 200. The first UE may be one of the end UEs 100 and 200 which receives a discovery message.

In operation 1401, the first UE may activate or start a first timer after a first path to a second UE determined as failed. The first timer may be a guard timer. The second UE may be one of the end UEs 100 and 200.

In operation 1403, the first UE may inactivate or stop the first timer upon receipt of a first discovery message from the second UE. In some embodiments, the first timer may inactivate or stop upon receipt of a first discovery message if the first timer does not expire. In operation 1405, the first UE may transmit a first acceptation message responsive to the first discovery message if the first discovery message is received when the first timer is active (or when the first timer does not expire).

In some embodiments of the method 1400, the first UE may release a connection to the second UE when the first timer expires. The connection to the second UE may be released by discarding end-to-end RRC connection context and PDCP configurations (e.g. RRC and PDCP entities) associated with the second UE. The first timer may expire because no corresponding acceptation message is received.

In some embodiments of the method 1400, the first discovery message may include an identifier associated with the first UE and the second UE. The first discovery message may include an identifier associated with the end-to-end connection between the first UE and the second UE. The identifier may indicate that such discovery message is for relay reselection of an on-going end-to-end PC5 RRC connection. The identifier may be one or more of APP ID, Link ID, Layer-2 ID, and etc.

In some embodiments of the method 1400, the first path may be determined as failed because of time out. The first UE may determine the first path as failed because the first UE does not receive any subsequent data units from the opposite end UE. The first UE may determine the first path as failed because the first UE does not receive any feedback responsive to the previous data units transmitted to the opposite end UE. In some embodiments of the method 1400, the first path may be determined as failed upon receipt of a failure message from a third UE. The third UE may transmit a failure message to an end UE and indicate that the other end UE is not reachable for the third UE. The third UE may be a relay UE.

In some embodiments of the method 1400, after the first path to the second UE is determined as failed, the first UE may stop generating data units for the second UE and/or stop transmitting data units to the second UE.

In some embodiments of the method 1400, the first acceptation message is transmitted to the second UE through a fourth UE and a first hop configuration is transmitted to the fourth UE with the first acceptation message. The first hop configuration may be PC5-RRC configurations for the hop between the first and fourth UEs. The fourth UE may be a relay UE.

In some embodiments, the method 1400 may further comprise receiving an establishment confirmation from the second UE. The establishment confirmation may be an end-to-end confirmation in a PC5-RRC message or a PC5-S message. A first status report (e.g., a PDCP status report) is received with the establishment confirmation. The method 1400 may further comprise transmitting a second status report (e.g., a PDCP status report) to the second UE. A request for the second status report may be received with the establishment confirmation.

In some embodiments, the method 1400 may further comprise discarding or ignoring the first discovery message if the first discovery message is received when the first timer expires.

In some embodiments, the method 1400 may further comprise transmitting a second acceptation message responsive to the first discovery message to the second UE if the first discovery message is received when the first guard timer expires. The second acceptation message includes a packet data convergence protocol (PDCP) configuration to establish a connection with the second UE.

In some embodiments, the method 1400 may further comprise transmitting a first rejection message to the second UE if the first discovery message is received when the first timer expires; and releasing a connection to the second UE. The connection to the second UE may be released by discarding end-to-end RRC connection context and PDCP configurations (e.g. RRC and PDCP entities) associated with the second UE.

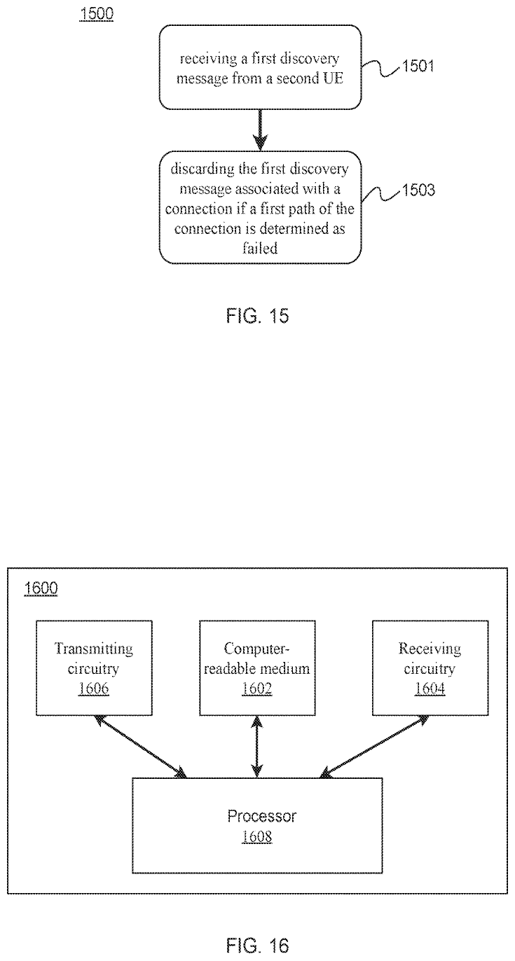

FIG. 15 is a flowchart of a method 1500 according to some embodiments of the present disclosure. The method 1500 may be performed by a first UE. In some embodiments, the first UE may be the relay UE 300 or 400.

In operation 1501, the first UE may receive a first discovery message from a second UE. The first timer may be a guard timer. The second UE may be an end UE or a relay UE.

In operation 1503, the first UE may discard the first discovery message associated with a connection if a first path of the connection is determined as failed. If a failure message related the connection has been transmitted by the first UE, the first path of the connection (which the first UE is involved) is noted as failed by the first UE.

In some embodiment of the method 1500, the first discovery message may be discarded within a given time period. The first path of the connection (which the first UE is involved) may be failed with a time period any may be restored after the timer period.

In some embodiment of the method 1500, the first path of the connection may be determined as failed after transmitting a failure message associated with the first path. The first path of the connection may be determined by the first UE after the first UE transmits a failure message associated with the first path.

In some embodiment, the method 1500 may further comprise transmitting the first discovery message; and receiving a first acceptation message and a first hop configuration from a third UE. The first acceptation message may be responsive to the first discovery message. The first hop configuration may be PC5-RRC configurations for the hop between the first and third UEs. The third UE may be an end UE or a relay UE. The method 1500 may further comprise transmitting the first acceptation message and a second hop configuration to the second UE. The second hop configuration may be PC5-RRC configurations for the hop between the first and third UEs. The second UE may be an end UE or a relay UE.

In some embodiment, the method 1500 may further comprise transmitting the first discovery message; receiving a first rejection message from a third UE, the first rejection message responsive to the first discovery message; and transmitting the first rejection message to the second UE. The second UE may be an end UE or a relay UE. The third UE may be an end UE or a relay UE.

FIG. 16 is a simplified block diagram of an apparatus 1600 according to some embodiments of the present disclosure. The apparatus 1600 may be one of the end UE 100, the end UE 200, the relay 300, and the relay 400.

Referring to FIG. 16, the apparatus 1600 may include at least one non-transitory computer-readable medium 1602, at least one receiving circuitry 1604, at least one transmitting circuitry 1606, and at least one processor 1608. Some embodiments of the present disclosure comprise at least one receiving circuitry 1604 and at least one transmitting circuitry 1606 and are integrated into at least one transceiver. The at least one non-transitory computer-readable medium 1602 may have computer executable instructions stored therein. The at least one processor 1608 may be coupled to the at least one non-transitory computer-readable medium 1602, the at least one receiving circuitry 1604 and the at least one transmitting circuitry 1606. The computer executable instructions can be programmed to implement a method with the at least one receiving circuitry 1604, the at least one transmitting circuitry 1606 and the at least one processor 1608. The method can be a method according to an embodiment of the present disclosure, for example, one of the methods shown in FIGS. 3-15.

Some embodiments of the present disclosure may be disclosed below:

Embodiment 1: A method for relay reselection, the method performed by a first UE and comprising:
activating a first timer after a first path to a second UE determined as failed;
transmitting a first discovery message; and
inactivating the first timer upon receipt of a first acceptation message responsive to the first discovery message.
   Embodiment 2: The method of Embodiment 1 further comprising:
releasing a connection to the second UE when the first timer expires.
   Embodiment 3: The method of Embodiment 1, wherein the first discovery message includes an identifier associated with the first UE and the second UE.
   Embodiment 4: The method of Embodiment 1, wherein the first path is determined as failed because of time out.
   Embodiment 5: The method of Embodiment 1, wherein the first path is determined as failed upon receipt of a failure message from a third UE.
   Embodiment 6: The method of Embodiment 1, further comprising, after the first path to the second UE determined as failed:
stopping generating data units for the second UE; or
stopping transmitting data units to the second UE.
   Embodiment 7: The method of Embodiment 6, further comprising:
receiving a first hop configuration from a fourth UE, wherein the first acceptation message is transmitted by the second UE through the fourth UE.
   Embodiment 8: The method of Embodiment 1, further comprising:
transmitting an establishment confirmation to the second UE.
   Embodiment 9: The method of Embodiment 8, wherein a first status report is transmitted with the establishment confirmation.
   Embodiment 10: The method of Embodiment 9, wherein a request for a second status report is transmitted with the establishment confirmation.
   Embodiment 11: The method of Embodiment 8, further comprising:
receiving a second status report from the second UE.
   Embodiment 12: the method of Embodiment 1 wherein if a packet data convergence protocol (PDCP) configuration is received with the first acceptation message, the method further comprises:
establishing a connection to the second UE based on the PDCP configuration.
   Embodiment 13: The method of Embodiment 1, further comprising:
discarding the first acceptation message if the first acceptation message is received when the first timer expires.
   Embodiment 14: The method of Embodiment 1, further comprising:
receiving a first rejection message from the second UE responsive to the first discovery message; and
releasing a connection to the second UE.
   Embodiment 15: A method for relay reselection, the method performed by a first UE and comprising:
activating a first timer after a first path to a second UE determined as failed; and
inactivating the first timer upon receipt of a first discovery message from the second UE; and
transmitting a first acceptation message responsive to the first discovery message if the first discovery message is received when the first timer is active.
   Embodiment 16: The method of Embodiment 15, further comprising:
releasing a connection to the second UE when the first timer expires.
   Embodiment 17: The method of Embodiment 15, wherein the first discovery message includes an identifier associated with the first UE and the second UE.
   Embodiment 18: The method of Embodiment 15, wherein the first path is determined as failed because of time out.
   Embodiment 19: The method of Embodiment 15, wherein the first path is determined as failed upon receipt of a first failure message from a third UE.
   Embodiment 20: The method of Embodiment 15, further comprising, after a first path to a second UE determined as failed:
stopping generating data units for the second UE; or
stopping transmitting data units for the second UE.
   Embodiment 21: The method of Embodiment 15, wherein the first acceptation message is transmitted to the second UE through a fourth UE and a first hop configuration is transmitted to the fourth UE with the first acceptation message.
   Embodiment 22: The method of Embodiment 15, further comprising:
receiving an establishment confirmation from the second UE.
   Embodiment 23: The method of Embodiment 22, wherein a first status report is received with the establishment confirmation.
   Embodiment 24: The method of Embodiment 23, wherein a request for a second status report is received with the establishment confirmation.
   Embodiment 25: The method of Embodiment 22, further comprising:
transmitting a second status reported to the second UE.
   Embodiment 26: The method of Embodiment 15, further comprising:
discarding the first discovery message if the first discovery message is received when the first timer expires.
   Embodiment 27: The method of Embodiment 15, further comprising:
transmitting a second acceptation message responsive to the first discovery message to the second UE if the first discovery message is received when the first guard timer expires, wherein the second acceptation message includes a packet data convergence protocol (PDCP) configuration to establish a connection with the second UE.
   Embodiment 28: The method of Embodiment 15, further comprising:
transmitting a first rejection message to the second UE if the first discovery message is received when the first timer expires; and
releasing a connection to the second UE.
   Embodiment 29: A method for relay reselection, the method performed by a first UE and comprising:
receiving a first discovery message from a second UE; and
discarding the first discovery message associated with a connection if a first path of the connection is determined as failed.
   Embodiment 30: The method of Embodiment 29, wherein the first discovery message is discarded within a time period.
   Embodiment 31: The method of Embodiment 29, wherein the first path of the connection is determined as failed after transmitting a failure message associated with the first path.
   Embodiment 32: The method of Embodiment 29, further comprising:
transmitting the first discovery message; and
receiving a first acceptation message and a first hop configuration from a third UE, the first acceptation message responsive to the first discovery message.
   Embodiment 33: The method of Embodiment 32, further comprising:
transmitting the first acceptation message and a second hop configuration to the second UE.
   Embodiment 34: The method of Embodiment 29, further comprising:
transmitting the first discovery message;
receiving a first rejection message from a third UE, the first rejection message responsive to the first discovery message; and
transmitting the first rejection message to the second UE.
   Embodiment 35: An apparatus, comprising:
at least one non-transitory computer-readable medium having computer executable instructions stored therein;
at least one receiver;
at least one transmitter; and
at least one processor coupled to the at least one non-transitory computer-readable medium, the at least one receiver and the at least one transmitter;
wherein the computer executable instructions are programmed to implement a method according to any one of Embodiments 1-34 with the at least one receiver, the at least one transmitter and the at least one processor.

The method according to embodiments of the present disclosure can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present disclosure provides an apparatus for emotion recognition from speech, including a processor and a memory. Computer programmable instructions for implementing a method for emotion recognition from speech are stored in the memory, and the processor is configured to perform the computer programmable instructions to implement the method for emotion recognition from speech. The method may be a method as stated above or other method according to an embodiment of the present disclosure.

An alternative embodiment preferably implements the methods according to embodiments of the present disclosure in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present disclosure provides a non-transitory, computer-readable storage medium having computer programmable instructions stored therein. The computer programmable instructions are configured to implement a method for emotion recognition from speech as stated above or other method according to an embodiment of the present disclosure.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A method for relay reselection, the method performed by a first user equipment (UE) and comprising:
activating a first timer after a first path to a second UE is determined as failed;
transmitting a first discovery message; and
inactivating the first timer upon receipt of a first acceptation message responsive to the first discovery message.

2. The method of claim 1, further comprising:
receiving a first hop configuration from a fourth UE, wherein the first acceptation message is transmitted by the second UE through the fourth UE.

3. The method of claim 1, further comprising:
transmitting an establishment confirmation to the second UE.

4. The method of claim 3, wherein a first status report is transmitted with the establishment confirmation.

5. The method of claim 3, further comprising:
receiving a second status report from the second UE.

6. The method of claim 1, further comprising:
receiving a first rejection message from the second UE responsive to the first discovery message; and
releasing a connection to the second UE.

7. An apparatus, comprising:
a receiving circuitry;
a transmitting circuitry;
a processor coupled to the receiving circuitry and the transmitting circuitry configured to cause the apparatus to:
activate a first timer after a first path to a second UE is determined as failed; and
inactivate the first timer upon receipt of a first discovery message from the second UE; and
transmit a first acceptation message responsive to the first discovery message if the first discovery message is received when the first timer is active.

8. The apparatus of claim 7, wherein the first acceptation message is transmitted to the second UE through a fourth UE and a first hop configuration is transmitted to the fourth UE with the first acceptation message.

9. The apparatus of claim 7, wherein the processor is configured to:
receive an establishment confirmation from the second UE.

10. The apparatus of claim 9, wherein a first status report is received with the establishment confirmation.

11. The apparatus of claim 9, wherein the processor is configured to:
transmit a second status reported to the second UE.

12. The apparatus of claim 7, wherein the processor is configured to:
transmit a first rejection message to the second UE if the first discovery message is received when the first timer expires; and
release a connection to the second UE.

13. (canceled)

14. (canceled)

15. An apparatus, comprising:
a receiver;
a transmitter; and
a processor coupled to the receiver and the transmitter configured to cause the apparatus to:
activate a first timer after a first path to a second user equipment (UE) is determined as failed;
transmit a first discovery message; and
inactivate the first timer upon receipt of a first acceptation message responsive to the first discovery message.

16. The apparatus of claim 15, wherein the processor is configured to:
receive a first hop configuration from a fourth UE, wherein the first acceptation message is transmitted by the second UE through the fourth UE.

17. The apparatus of claim 15, wherein the processor is configured to:
transmit an establishment confirmation to the second UE.

18. The apparatus of claim 17, wherein a first status report is transmitted with the establishment confirmation.

19. The apparatus of claim 17, wherein the processor is configured to:
receive a second status report from the second UE.

20. The apparatus of claim 15, wherein the processor is configured to:
receive a first rejection message from the second UE responsive to the first discovery message; and
release a connection to the second UE.
